(19) United States
(12) Patent Application Publication
(10) Pub. No.: US 2003/0024387 A1
(43) Pub. Date: Feb. 6, 2003

(54) Piston ring improvements for a stirling engine

(76) Inventors: Christopher C. Langenfeld, Nashua, NH (US); Prashant Bhat, Manchester, NH (US)

Correspondence Address: BROMBERG & SUNSTEIN LLP, 125 SUMMER STREET, BOSTON, MA, 02110-1618, US

(21) Appl. No.: 10/175,502

(22) Filed: Jun. 19, 2002

Related U.S. Application Data
(60) Provisional application No. 60/299,696, filed on Jun. 20, 2001.

(51) Int. Cl. F16J 9/00

(52) U.S. Cl. 92/248

(57) ABSTRACT

A method for sealing a working zone in a cylinder of a thermal cycle engine. The method includes providing a seal ring within a ring groove of the piston, and, additionally, applying a backing force on the seal ring by means of a backing ring having a width that varies with circumferential displacement from a fiducial circumferential position on the backing ring. The backing force is provided by means of a backing ring that has a non-circular shape in an uncompressed condition.

This application claims priority from U.S. provisional patent application serial No. 60/299,696, filed Jun. 20, 2001, entitled “Piston Ring Improvements for a Stirling Engine” and bearing attorney docket number 2229/108, the disclosure of which is incorporated herein, in its entirety, by reference.

### TECHNICAL FIELD

The present invention pertains to methods for sealing a working zone within a cylinder of a thermal cycle engine, and to piston rings for a thermal cycle engine and more particularly to rings that provide sealing for non-lubricated pistons.

### BACKGROUND OF THE INVENTION

Stirling cycle machines, including engines and refrigerators, have a long technological heritage, described in detail in Walker, Stirling Engines, Oxford University Press (1980), incorporated herein by reference. The principle underlying the Stirling cycle engine is the mechanical realization of the Stirling thermodynamic cycle: isovolumetric heating of a gas within a cylinder, isothermal expansion of the gas (during which work is performed by driving a piston), isovolumetric cooling, and isothermal compression.

Stirling cycle engines have not generally been used in practical applications, due to several daunting engineering challenges to their development. These involve such practical considerations as efficiency, vibration, lifetime, and cost.

The advantages of a welded structure for containment of the high pressure working gas employed in a Stirling engine emphasize the need for long-lived components. The piston seals, which are intended to prevent the flow of working gas past the piston, must seal against the wall of the cylinder while in motion parallel to the wall. The seal must be provided in the face of wear of the rings due to friction, compounded in the case of Stirling engines which, due to the extreme operating temperatures, are typically not lubricated. Thus a unique requirement exists for a mechanism to seal a moving interface under extreme thermal conditions in the absence of lubrication.

### SUMMARY OF THE INVENTION

In accordance with preferred embodiments of the present invention, a method is provided for sealing a working zone in a cylinder of a thermal cycle engine. The method includes providing a seal ring within a ring groove of the piston, and, additionally, applying a backing force on the seal ring by means of a backing ring having a width that varies with circumferential displacement from a fiducial circumferential position on the backing ring. In accordance with an alternate embodiment of the invention, the backing force is provided by means of a backing ring that has a non-circular shape in an uncompressed condition.

In accordance with further embodiments of the invention, the seal ring, in either of the above cases, may be closed at a single lap-joint for providing a pressure seal. Additionally, the motion of the piston within the cylinder of a thermal cycle engine may be guided, in accordance with other embodiments of the invention, by providing a guide ring surrounding the piston at a position displaced axially from a plane in which sealing against the wall of the cylinder is achieved. A further embodiment of the invention combines the seal ring as described with a separate guide ring.

In accordance with another embodiment of the invention, a piston seal for sealing a working zone in a cylinder of the thermal cycle engine includes a seal ring disposed within a ring groove of a piston capable of driven motion within the cylinder and a backing ring for applying a backing force on the seal ring. The backing ring is in contact with an inner surface of the seal ring and has a width that varies with circumferential displacement from a fiducial circumferential position on the backing ring. In accordance with another embodiment of the invention the backing ring has a non-circular shape in an uncompressed condition.

### BRIEF DESCRIPTION OF THE DRAWINGS

The invention will be more readily understood by reference to the following description, taken with the accompanying drawings, in which:

FIG. 1 is a side view in cross section of a Stirling cycle engine in which the embodiments of the present invention may advantageously be applied;

FIG. 2 is a partial cross sectional view of a piston with a seal ring, backup ring, and guide ring, in accordance with preferred embodiments of the present invention;

FIG. 3a shows a top view of a circular backup ring, shown as uncompressed and under compression;

FIG. 3b is a diagram indicating the radial thrust forces exerted by the seal ring on the cylinder wall by virtue of the ring embodiment of FIG. 3a;

FIG. 4 is a perspective view of a seal ring and a backup ring of tapered width in accordance with an embodiment of the present invention;

FIG. 5a shows a top view of an oval backup ring, in accordance with an embodiment of the present invention, showing a circular shape upon compression;

FIG. 5b is a diagram indicating the radial thrust forces exerted by the seal ring on the cylinder wall by virtue of the ring embodiment of FIG. 5a; and

FIG. 6 shows a perspective view of the guide ring, in accordance with an embodiment of the present invention.

### DETAILED DESCRIPTION OF PREFERRED EMBODIMENTS

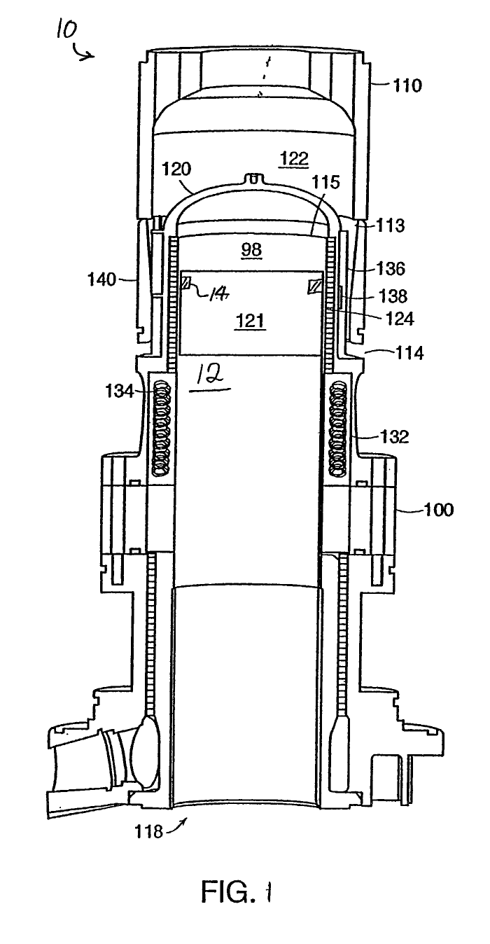

Many mechanical layouts of Stirling cycle engines are known in the art, and the particular Stirling engine designated generally by numeral 10 is shown merely for illustrative purposes. A piston 121 (otherwise referred to herein as a “expansion piston”) and a second piston (also known as an “compression piston,” and not shown in FIG. 1) move in phased reciprocating motion within separate, interconnected, cylinders. Piston seals 14 prevents the flow of a working fluid contained within expansion volume 98 from escaping around piston 121. Other key components of the Stirling cycle engine are labeled and are described in detail in related application, U.S. Ser. No. 09/517,245, filed Mar. 2, 2000, which is incorporated herein by reference.

Expansion volume 98 is surrounded on its sides by expansion cylinder liner 115, disposed, in turn, inside heater head 100 and typically supported by the heater head. The expansion piston 121 travels along the interior of expansion cylinder liner 115. As the expansion piston travels toward closed end 120 of heater head 100, the working fluid within the heater head is displaced and caused to flow through flow channels defined by the outer surface of the expansion cylinder liner 115 and the inner surface of heater head 100.

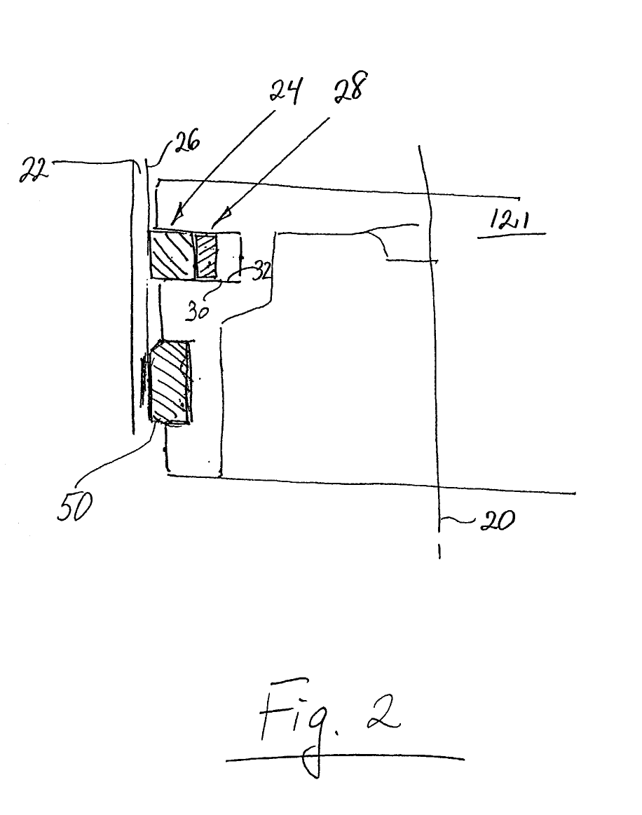

FIG. 2 shows a partial cross section of piston 121, driven along central axis 20 of cylinder, or cylinder liner 22. Seal ring 24 provides a seal against wall 26 of the cylinder. Wall 26 is typically a hardened metal (preferably 60-62 RC) such as steel finished to a smooth surface finish. A backing ring 28 (also referred to herein as a ‘back-up ring’) is sprung to provide a thrust force against the seal ring thereby providing sufficient contact pressure to ensure sealing around the entire outward surface of the ring. Seal ring 24 and backing ring 28 may together be referred to as a composite ring.

The material of seal ring 24 is chosen by considering a balance between the coefficient of friction of the seal ring against the cylinder wall and the wear on the ring it engenders. In applications in which piston lubrication is not possible, such as at the high operating temperatures of a Stirling cycle engine, the use of engineering plastic rings is preferred. The preferred composition is a nylon matrix loaded with a lubricating and wear-resistant material. Examples of such lubricating materials include PTFE/silicone, PTFE, graphite, etc. Examples of wear-resistant materials include glass fibers and carbon fibers. Examples of such engineering plastics are manufactured by LNP Engineering Plastics, Inc. of Exton, Pa. Backing ring 28 is preferably a metal.

The fit between seal ring 24 and seal ring groove 30 is preferably a clearance fit (˜0.002″), while the fit of backing ring 28 is preferably a looser fit, of the order of ˜0.005″. Seal ring 24 provides a pressure seal against cylinder wall 26 and also one of the surfaces 32 of the seal ring groove 30, depending on the direction of the pressure difference across the ring and the direction of piston travel.

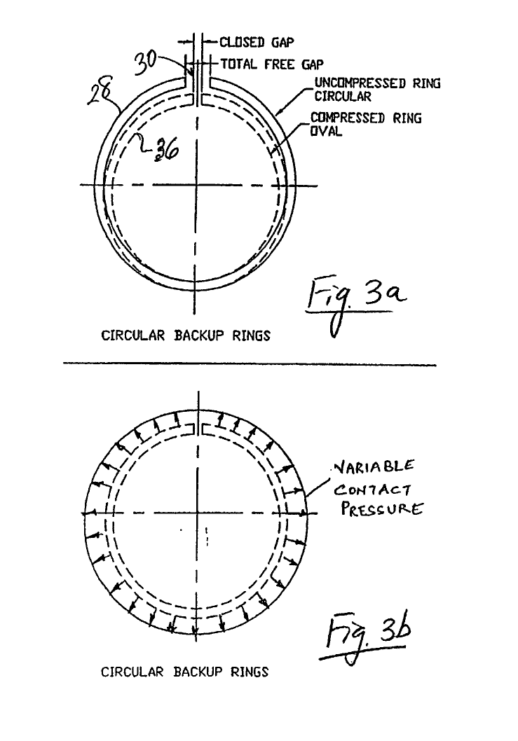

FIGS. 3a and 3b show that if the backing ring is essentially circularly symmetrical, but for gap 30, it will assume, upon compression, an oval shape, as shown by dashed backing ring 36. The result may be an uneven thrust force exerted on the seal ring, and thus an uneven pressure of the seal ring against the cylinder wall, causing uneven wear of the seal ring and premature failure of the seal.

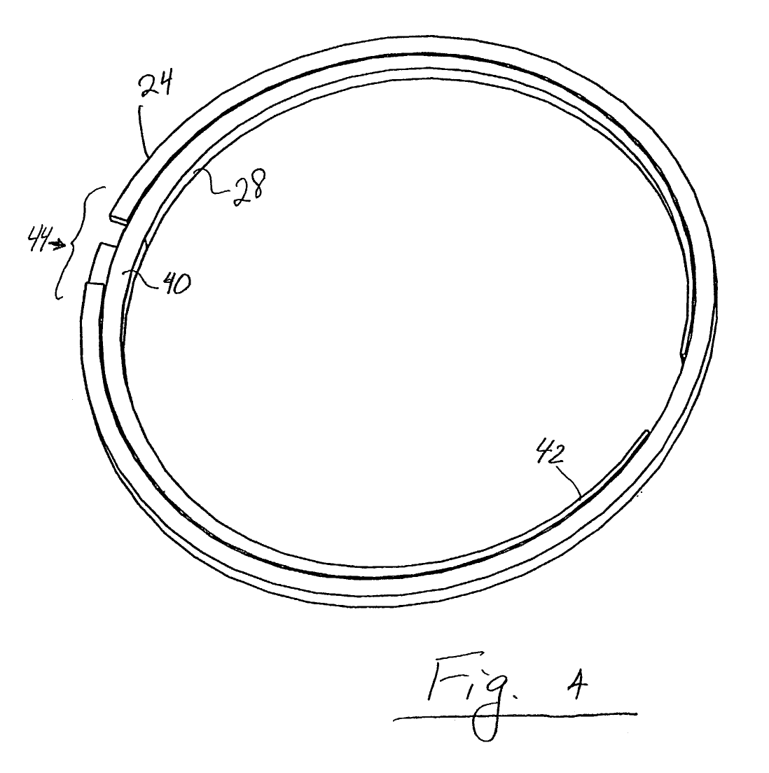

A solution to the problem of uneven thrust force, in accordance with an embodiment of the invention, is a backing ring 28 having a cross-section varying with circumferential displacement from the gap 30, as shown in FIG. 4. A tapering of the width is shown from the position denoted by numeral 40 to the position denoted by numeral 42. Also shown in FIG. 4 is a lap joint 44 providing for circumferential closure of seal ring 24. As some seals will wear significantly over their lifetime, backing ring 28 should supply an even pressure of a range of movement. The tapered backing ring 28 shown in FIG. 4 may provide this advantage.

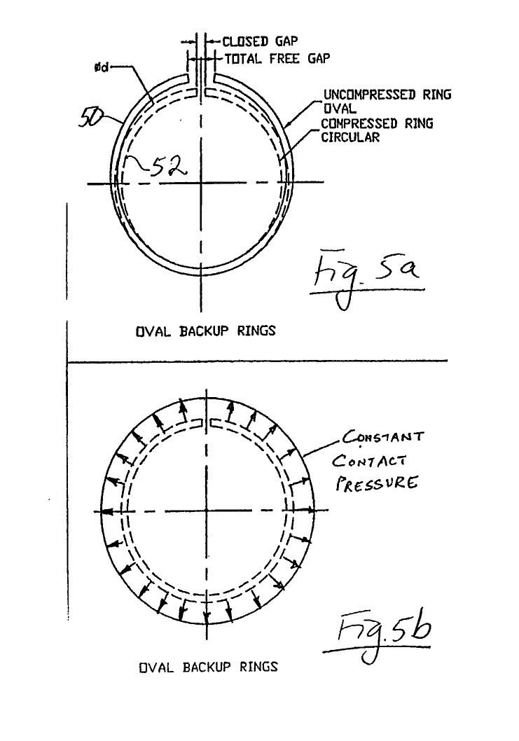

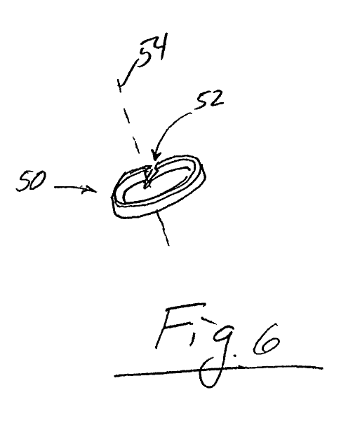

FIG. 5 illustrates another solution to the problem of uneven thrust force of the seal ring against the cylinder wall, in accordance with a further embodiment of the present invention. As shown in FIG. 5a, backing ring 50 is fashioned in an oval shape, so that upon compression within the cylinder, the ring assumes the circular shape shown by dashed backing ring 52. A constant contact pressure between the seal ring and the cylinder wall may thus be provided by an even radial thrust force of the backing ring, as depicted in FIG. 6a.

Referring again to FIG. 2, a guide ring 50 may also be provided, in accordance with embodiments of the present invention, for bearing any side load on piston 121 as it moves up and down the cylinder. Guide ring 50 is also preferably fabricated from an engineering plastic material loaded with a lubricating material. A perspective view of guide ring 50 is shown in FIG. 6. An overlapping joint 52 is shown and may be diagonal to the axis 54 of the ring, for example.

The devices and methods described herein may be applied in other applications besides the Stirling engine in terms of which the invention has been described. The described embodiments of the invention are intended to be merely exemplary and numerous variations and modifications will be apparent to those skilled in the art. All such variations and modifications are intended to be within the scope of the present invention as defined in the appended claims.

We claim:

1. A method for sealing a working zone in a cylinder of a thermal cycle engine, the method comprising:
a. providing a seal ring within a ring groove of a piston capable of driven motion within the cylinder; and
b. applying a backing force on the seal ring by means of a backing ring having a width that varies with circumferential displacement from a fiducial circumferential position on the backing ring.

2. A method for sealing a working zone in a cylinder of a thermal cycle engine, the method comprising:
a. providing a seal ring within a ring groove of a piston capable of driven motion within the cylinder; and
b. applying a backing force on the seal ring by means of a backing ring having a non-circular shape in an uncompressed condition.

3. A method according to claim 1, wherein the seal ring is closed at a single lap-joint for providing a pressure seal.

4. A method according to claim 2, wherein the seal ring is closed at a single lap-joint for providing a pressure seal.

5. A method for guiding the motion of a piston within the cylinder of a thermal cycle engine, the method comprising:
a. providing a guide ring surrounding the piston at a position displaced from a plane in which sealing against the wall of the cylinder is achieved.

6. A method according to claim 1, further including providing a guide ring surrounding the piston at a position displaced from a plane in which sealing against the wall of the cylinder is achieved.

7. A method according to claim 2, further including providing a guide ring surrounding the piston at a position displaced from a plane in which sealing against the wall of the cylinder is achieved.

8. A piston seal for sealing a working zone in a cylinder of the thermal cycle engine, the piston seal comprising:
a. a seal ring disposed within a ring groove of a piston capable of driven motion within the cylinder; and
b. a backing ring in contact with an inner surface of the seal ring, the backing ring for applying a backing force on the seal ring and having a width that varies with circumferential displacement from a fiducial circumferential position on the backing ring.

9. A piston seal for sealing a working zone in a cylinder of a thermal cycle engine, the piston seal comprising:
a. a seal ring disposed within a ring groove of a piston capable of driven motion within the cylinder; and
b. a backing ring in contact with an inner surface of the seal ring, the backing ring for applying a backing force on the seal ring and having a non-circular shape in an uncompressed condition.

10. A piston seal according to claim 8, wherein the seal ring is closed at a single lap-joint for providing a pressure seal.

11. A piston seal according to claim 9, wherein the seal ring is closed at a single lap-joint for providing a pressure seal.
